(19) United States
(12) Patent Application Publication
(10) Pub. No.: US 2012/0221494 A1
(43) Pub. Date: Aug. 30, 2012

(54) REGULAR EXPRESSION PATTERN MATCHING USING KEYWORD GRAPHS

(75) Inventors: Davide Pasetto, Dublin (IE); Fabrizio Petrini, Yorktown Heights, NY (US)

(73) Assignee: International Business Machines Corporation, Armonk, NY (US)

(21) Appl. No.: 13/035,488

(22) Filed: Feb. 25, 2011

(51) Int. Cl. G06F 15/18

(52) U.S. Cl. 706/12

(57) ABSTRACT

Expanding a regular expression set into an expanded expression set that recognizes a same language as the regular expression set and includes more expressions than the regular expression set, with less operators per expression includes: logically connecting the expressions in the regular expression set; parsing the expanded expression set; transforming the parsed expanded expression set into a Glushkov automata; transforming the Glushkov automata into a modified deterministic finite automaton in order to maintain fundamental graph properties; combining the modified DFA into a keyword graph using a combining algorithm that preserves the fundamental graph properties; and computing an Aho-Corasick fail function for the keyword graph using a modified algorithm to produce a modified Aho-Corasick graph with a goto and a fail function and added information per state.

### GOVERNMENT RIGHTS

This invention was made under United States Government Contract H98230-07-C-0409. The United States Government has certain rights in this invention.

### FIELD OF THE INVENTION

The invention disclosed broadly relates to the field of pattern matching, and more particularly relates to the field of pattern matching using keyword graphs.

### BACKGROUND OF THE INVENTION

Exact set matching, also known as keyword matching or keyword scanning, is widely used in a number of applications, such as virus scanning and intrusion detection. The traditional exact set matching problem definition is to locate all occurrences of any pattern in a set inside of an input string.

The primary limitation of this approach is that it restricts the definition to a static keyword. Recent intrusion detection software and virus scanners use regular expressions to be able to capture more precise information and to perform deep packet scanning Deep packet inspection is arguably one of the applications whose processing needs are growing faster, due to the combined increase in network speed, now approaching 10 Gbits/sec, with 40 Gbits/sec rapidly appearing on the horizon, and the network threats, such as virii, malware and network attacks.

A powerful mechanism to express families of patterns is through regular expressions. Matching input data against a set of regular expressions can be a very complex task and greatly depends on the features implemented in regular expressions. Several different formalisms are available, each building on the features of a “simpler syntax” and adding more features. The regular expression set matching problem can be defined as: given an input string, locate all occurrences of substrings matching a pattern in a regular expression set.

Other than Deep Packet Inspection, regular expression applicability is very broad. Several programming languages (e.g., perl, php) directly provide regular expression support to ease programmer tasks when dealing with text analysis. Extended context free grammars (that is context free grammars with regular expressions on the right-hand side) constitute a basic tool in every high level parser generator. Newer anti-virus software use regular expressions to scan for virus signatures in files and data (previous generation antivirus software used keyword scanning but its limited expressiveness was prone to dictionary explosion and false matching).

XML parse and rewrite applications (which means most of current generation web services) are based on selecting the proper tag in the hierarchy using a path expression, which can easily be expressed as a regular expression. Genome researchers need to match DNA base sequences and patterns in their data; while very basic patterns can be searched using keywords; the more advanced require something able to express more general patterns.

The traditional approaches for handling regular expressions are to build either a Non-deterministic Finite Automaton (NFA) or a Deterministic Finite Automaton (DFA) from the expression set and simulate the execution of these finite state automata. The drawback to this approach is that, while it can run very fast in linear time, NFAs may require more than a state traversal per input character, and therefore are potentially slow. DFAs require an exponential number of states; this makes the traditional approaches not feasible except for very simple regular expressions.

The main problem with the NFA approach is its non determinism, which leads to either exponential time required to simulate it using backtrack, or exponential space required for encoding every possible output state after each transition.

The main problems with the DFA approach are the inability to remember that it is currently matching a specific pattern (which forces a complete state expansion thus leading to exponential memory requirements) and the inability to count transitions (which again forces a complete expansion of every alternative, thus leading again to exponential space requirements).

To overcome these difficulties, and gain a matching speed, several researchers approached the problem, each one from a different direction. A list of disclosed techniques to attack this complex problem follows:

Mechanisms to compress the NFA matching state.

Mechanisms to use bit level parallelism when simulating NFA.

Mechanisms to compress the DFA matching states.

Mechanisms to use bit level parallelism when simulating DFA.

Reduce the available operators to have a simpler formalism to control state explosion.

Modify the match semantic (for example matching shortest strings only or avoid matching expressions inside Kleene closures) to control the state explosion.

Partition regular a expression set into different sub-sets to keep state explosion under control (and getting multiple parallel automata).

Modify the DFA formalism to encode more information in the graph and reduce space requirements (e.g. Delayed Input DFA).

Partition the DFA into a “fast portion” and a “slow portion”, where the fast portion matches the beginning of a regular expression and eventually triggers the slow portion (bifurcated pattern matching).

Adding a match history to a DFA, which will allow the use of conditions on DFA edges (History Based DFA-H-FA).

Adding counters to a history based DFA to allow conditions based on number of symbols recognized (History based counting DFA-H-cFA).

### SUMMARY OF THE INVENTION

Briefly, according to an embodiment of the invention a method comprises steps or acts of using an input/output interface for obtaining the regular expression set; using a processor device for: expanding the regular expression set into an expanded expression set that recognizes a same language as the regular expression set and comprises more expressions than the regular expression set, with less operators per expression; wherein the expanding comprises logically connecting the expressions in the regular expression set; parsing the expanded expression set; transforming the parsed expanded expression set into a Glushkov automata; transforming the Glushkov automata into a modified deterministic finite automaton (DFA) in order to maintain fundamental graph properties; combining the modified DFA into a keyword graph using a combining algorithm that preserves the fundamental graph properties; computing an Aho-Corasick fail function for the keyword graph using a modified algorithm to produce a modified Aho-Corasick graph with a goto( ) and a fail function and added information per state; wherein said modified Aho-Corasick graph can be executed by an unmodified Aho-Corasick engine at a same matching speed and match a large class of expressions.

The method can also be implemented as machine executable instructions executed by a programmable information processing system or as hard coded logic in a specialized computing apparatus such as an application-specific integrated circuit (ASIC).

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is a flowchart of a method according to an embodiment of the invention.

FIG. 2 is a keyword graph of a Glushkov automata with an unrolled “tight” loop, according to an embodiment of the present invention;

FIG. 3 is the graph of FIG. 2 after transforming the automata into a DFA, according to an embodiment of the present invention;

FIG. 4 is a graph showing an example of loop unrolling, according to an embodiment of the present invention;

FIG. 5 is the graph of FIG. 4 with a new edge, according to an embodiment of the present invention;

FIG. 6 shows the graph after combining, according to an embodiment of the present invention;

FIG. 7 shows the graph of an unroll operation, according to an embodiment of the present invention;

FIG. 8 shows the graph of a loop combining operation, according to an embodiment of the present invention;

FIG. 9 shows the graph of another loop combining operation, according to an embodiment of the present invention;

FIG. 10 shows the graph of another loop combining operation, according to an embodiment of the present invention;

FIG. 11 shows the graph of a loop transformation operation, according to an embodiment of the present invention;

FIG. 12 shows the graph of a loop combining operation, according to an embodiment of the present invention;

FIG. 13 shows the graph of a loop transformation operation, according to an embodiment of the present invention;

FIG. 14 is a highly simplified block diagram of a computing system configured according to an embodiment of the present invention;

FIG. 15 is a flowchart depicting the processing performed by a compiler according to an embodiment of the present invention;

FIG. 16 is a flowchart of the processing steps that occur at runtime, according to an embodiment of the present invention; and

FIG. 17 is a flowchart of a reduced set of runtime processing steps, according to the known art.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

We describe a novel method for performing a high speed regular expression (regexp) set match on an input stream. This method has applicability in multiple areas, such as network intrusion detection, antivirus software, XML processing, and DNA analysis. The method, according to an embodiment of the present invention, builds a special Deterministic Finite Automaton (DFA), along with the runtime algorithm to efficiently execute the automaton. The novel DFA is a single, composite, one pass scan and memory efficient solution for regular expression set matching. The key aspect of the invention is a step of transforming each non-deterministic automata (NDA) into a specific deterministic automata (DA) having the same predefined properties. With this invention, we are able to combine different regexp operations in the same set, with the ability to mix and match operators.

A deterministic finite automaton (DFA) is the name given to a machine or process where, in any state, each possible input character leads to at most one new state. From internet article: In a deterministic finite automaton (DFA), in any state, each possible input letter leads to at most one new state. The NFA for a regular expression is built up from partial NFAs for each sub-expression, with a different construction for each operator. The partial NFAs have no matching states: instead they have one or more dangling arrows, pointing to nothing. The construction process will finish by connecting these arrows to a matching state.

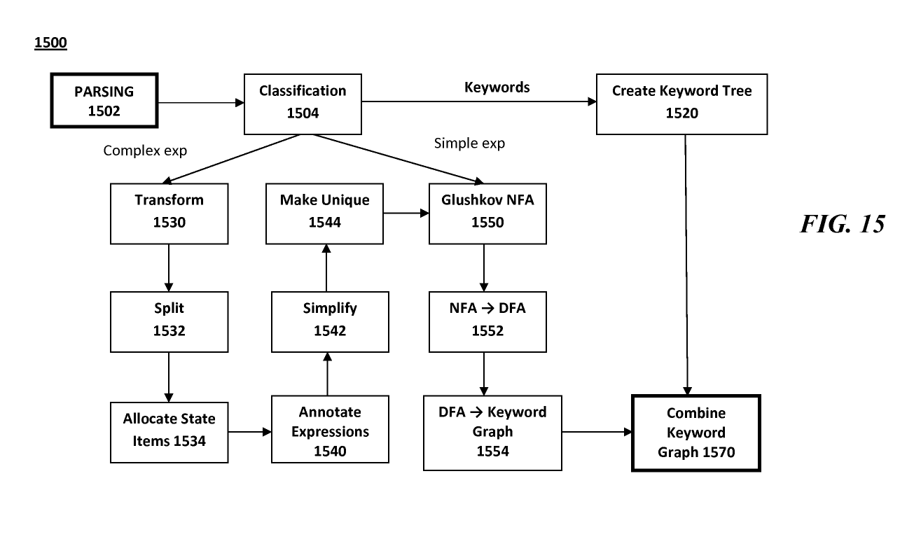

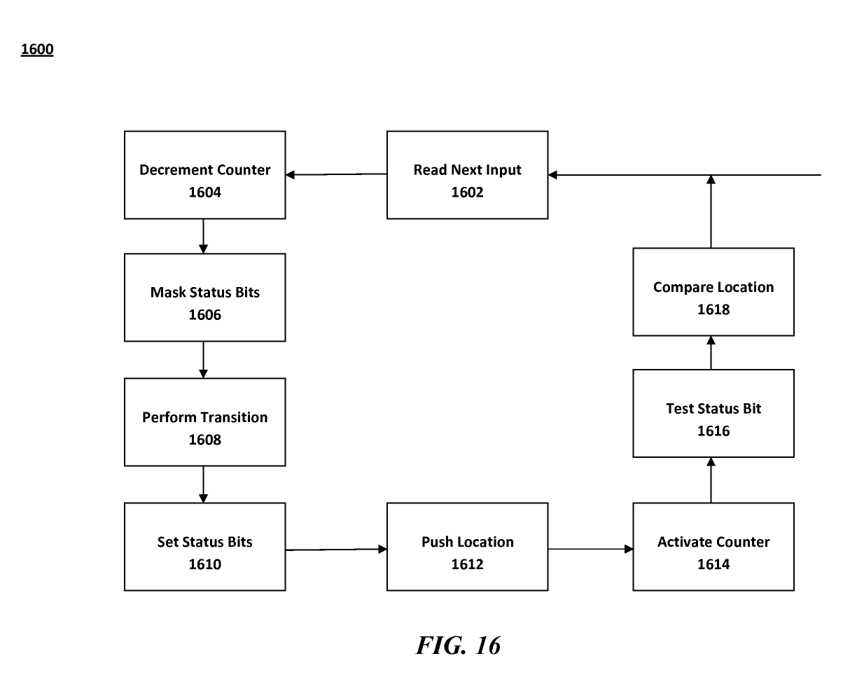

Referring now to the drawings and to FIG. 15 in particular, we discuss a flowchart 1500 depicting the processing performed by a compiler configured to operate according to an embodiment of the present invention. The main processing steps are: Parsing step 1502, Classification step 1504, Create Keyword Tree 1520 and finally, Combine Keyword Graph 1570. The Classification step 1504 proceeds as follows for complex expressions:

In step 1530 we transform the expressions into a Glushkov automata, then in step 1532 we split the complex regular expressions that cannot be handled in the unmodified Aho-Corasick executor into parts connected using status bits, position location and tail counters. An example of regular expression transformation follows. After the split in step 1534 we allocate state items, then annotate the expressions in step 1540. After that, the expressions are simplified in step 1542 and then made unique in step 1544.

Up to this point, from steps 1530 to 1544, the processing has been performed for complex expressions. For regular expressions, and in continuation of the processing for complex expressions, we construct a Glushkov NFA in step 1550. Then we transform the NFA to a DFA in step 1552. Following this, we convert the DFA into a keyword graph in step 1554. Finally, in step 1570, a keyword graph is constructed.

Regular expression transformation.

The steps 1550-1650 proceed by taking a list of regular expressions and applying a set of rules, transforming each expression in one or more expressions. The process iterates until the compiler is satisfied by the “form” of the expressions. Sample rules are:

* collapse_alternate

Transform “(A|B|C|F)” Into “[A-CF]”

* simplify_expression (OPTIONAL)

Remove trailing “A?” “A*” “A{,m}”]

Transform trailing “A+” Into “A”

Transform trailing “A{n,m}” Into “A{n,n}”

* simplify_expression_2 (OPTIONAL)

Remove starting “A?” “A*” “A{,m}”

Transform starting “A+” Into “A”

Transform starting “A{n,m}” Into “A{n,n}”

* expand_or

Transform the expression into one or more expressions splitting on “top level” or operators:

Example: “alpha|beta” Becomes

“alpha” “beta”

NOTE: “(alpha|beta)gamma” will NOT be expanded since the “|” is not “top level”

* glue_questions

Transform “[0-9]?[0-9]?[0-9]?” Into “[0-9]{0,3}”

* glue_questions_star

Transform “[0-9]?[0-9]*” Into “[0-9]*”

Transform “[0-9]{n,m}[0-9]*” Into “[0-9]{n,}”

* glue_questions_plus}

Transform “[0-9]?[0-9]+” Into “[0-9]{1,}”

Transform “[0-9]{n,m} [0-9]+” Into “[0-9]{n+1,}”

* expand_plus

Transform “A+” Into “AA*”]

* expand_question

Computes combinatorial expansion of all ‘?’ operator

Example: “AB?C?EF” Becomes:

“AEF” “ABEF” “ACEF” “ABCEF”

* glue_dots

Transform “ . . . ” Into “.{0,3}”

* expand_range.

Transform “[0-9]{3}” into “[0-9] [0-9] [0-9]”

Transform “[0-9]{3,}” into “[0-9][0-9][0-9][0-9]*”

Transform “[0-9]{3,5}” into “[0-9][0-9][0-9][0-9]{,2}”

PARAMETER maximum # of chars in character set to expand

PARAMETER maximum length to expand

We started with the “well known” Aho-Corasick algorithm, which is designed to match keywords and not regular expression. We studied innovative techniques to modify the Aho-Corasick algorithm to match regular expression instances instead of keywords. The expression set is first expanded by an automatic simplification system, which transforms the expression set into a different set recognizing the same language but containing more expressions with fewer operators per expression. This invention differs from the Aho-Corasick algorithm in at least the following key features:

1. Aho-Corasick provides a mechanism to build a keyword tree with keywords; we extend this to build keyword graphs (that contain loops).

2. Aho-Corasick provides a mechanism to transform the tree in a DFA computing a failure function; we provide a mechanism to turn a keyword graph in a DFA computing a failure function;

3. Aho-Corasick is a DFA for matching keywords only; we match regular expressions;

4. Aho-Corasick does not provide any mechanism for compacting the size of the tree (it does not need them); we provide a large set of mechanisms that compact the number of states since regular expression DFA can require an exponential number of states;

5. Aho-Corasick runtime is composed by “read next input- perform transition;” we extend the runtime with a modular set of changes that support the various state compacting techniques.

6. Aho-Corasick uses the Glushkov automata (non-deterministic) as an intermediate step in the compiler; we build a deterministic automata;

7. Glushkov recognizes a single regular expression; we match a set of regular expressions.

The Aho-Corasick algorithm is limited to operating on keywords only. The modified algorithm according to the invention 1) changes the compilation phase to operate on expressions that add loops in the graph; and 2) change the runtime to verify conditions during transition processing (realtime).

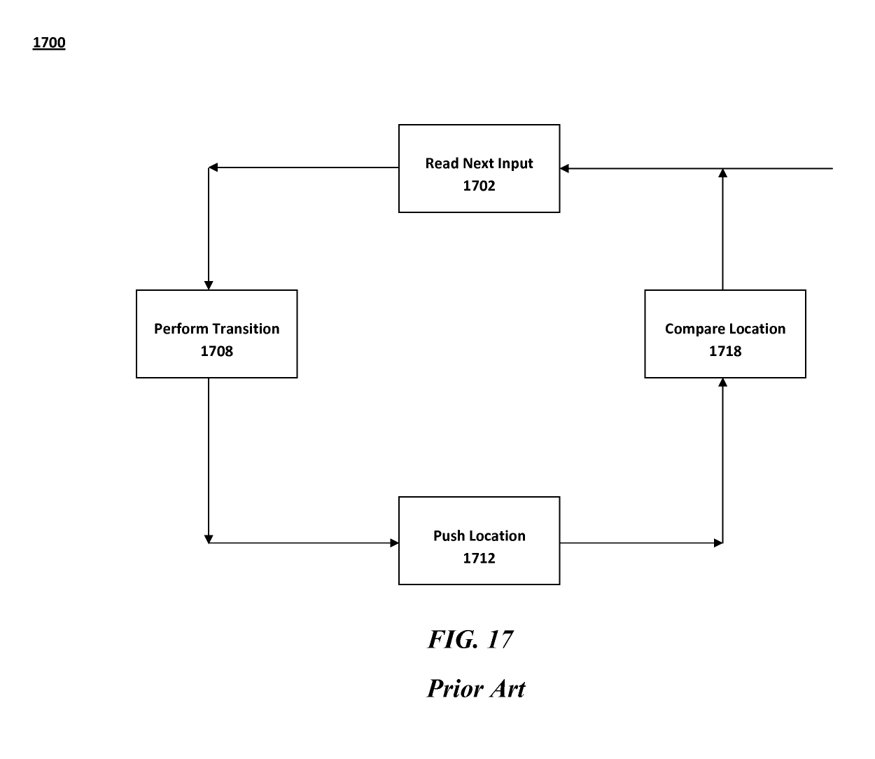

The iterative runtime processing steps for a method according to the invention are shown in flowchart 1600. First, the input is read in step 1602. Then, the counter is decremented in step 1604, following which the status bits are masked in step 1606. The transition step 1608 is performed, after which the status bits are set in step 1610. The location is pushed in step 1612. The counter is activated (step 1614). The status bits are tested in step 1616 and the location is compared in step 1618. The process then repeats with step 1602. FIG. 17 shows another possible runtime flowchart containing only a subset functionalities, showing only the read (step 1702), transition (step 1708), push (step 1712) and compare (step 1718) steps.

The expressions are then parsed and transformed into Glushkov automata, which is an NFA formalism with “interesting” properties, such as being epsilon free, homogeneous and strongly stable for every maximal orbit. We then DFA-ize the Glushkov automata maintaining the fundamental property. We combine the DFA-Glushkov into a keyword graph that is a “rooted graph”, with a combining algorithm that preserves the homogeneously, strong stability and strong transverse properties (the “interesting” properties). We finally compute the Aho-Corasick fail function F( ); the resulting graph can be executed by an unmodified Aho-Corasick engine at same matching speed and match a large class of expressions.

In order not to have state explosion if character classes are present, the expression should not contain:

a) “.*” (e.g. not “pippo.*abc”);

b) an implied backtrack (e.g. not “pippo[a-z]*abc”);

c) sequences of wilcards (e.g. not “pippo . . . pluto”); and

d) wide character class closure (e.g. not “pippo[a-z]*1.0”);

We designed a set of changes to the Aho-Corasick algorithm to maintain the speed and simplicity of the executor but also extend the set of recognized expressions. These changes are implemented inside the automatic simplification system, which splits the complex regular expressions (which cannot be handled in the unmodified Aho-Corasick executor) into parts connected using status bits, position location and tail counters.

The method compiles a regular expression set into a single modified Aho-Corasick DFA and uses it with a runtime engine able to detect in a single pass every substring (including overlapping substrings) matching any regular expression set pattern instance.

The modified Aho-Corasick DFA is created by transforming the regular expression set (an example provided above) into a different set recognizing the same language; the new set is composed by simpler regular expressions connected using various features, like status bits, location memory, and counters. The novelty of the modified Aho-Corasick DFA is highlighted in these three features which have not been used in regexp processing to date: 1) we examine the conditions (status bits, location, and so on) when we enter one state; 2) we combine the conditions in a data structure that can be vectorized; and 3) we use “position memory” which stores a specific stream position and compares it. Every expression in the new set is then converted to Glushkov automata NFA, which is then turned into a keyword graph DFA. All the keyword graphs are then combined together using a special combining algorithm which allows computing the Aho-Corasick failure function using the original algorithm with minor changes. The runtime engine is a standard Aho-Corasick runtime modified with proper handling of the connecting features (status bits, location memory and counters). This approach produces a single, composite, one pass scan and memory efficient DFA.

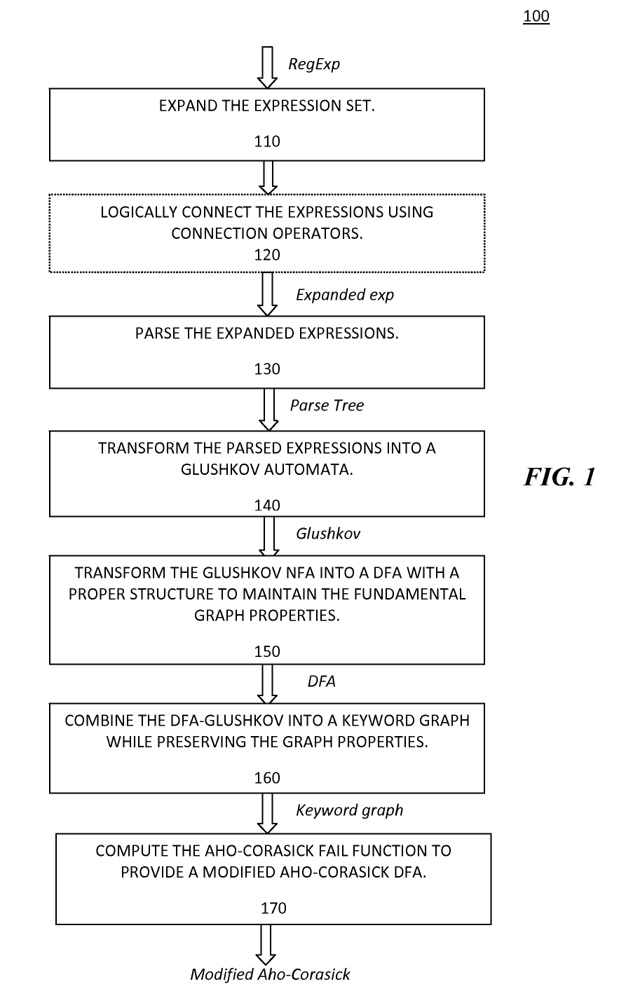

Referring now to the drawings and to FIG. 1 in particular, there is shown a high-level flow chart 100 of the process steps according to an embodiment of the present invention. In Step 110 the regular expression set is first expanded by an automatic simplification system, which transforms the expression set into a different set recognizing the same language but containing more expressions with less operators per expression. In step 120 the expressions may be logically “connected” one to another using a set of connection operators, such as status bits, location memory and counters. Note that this step is optional if the expressions are already in a “simple enough” form where no simplification is needed.

Next, in step 130 the expanded expressions are then parsed. This entails reading the expressions and transforming them into the standard parse tree that is used to represent a regexp. After parsing, in step 140 the parsed expressions are transformed to Glushkov automata, which are an NFA formalism with “interesting” properties, such as being epsilon free, homogeneous and strongly stable for every maximal orbit. From a parse tree, it is then possible to build a number of slightly different automata formalisms. The novelty is found in the sequence used here: regexp→parse tree→Glushkov→DFA with strong stability and homogeneity→combining all DFAs

The processing then continues at step 150 by transforming the Glushkov NFA into a DFA with a proper structure in order to maintain the fundamental graph properties we require. Next, in step 160, the system then combines the DFA-Glushkov into a keyword graph (that is a “rooted graph”) using a combining algorithm that preserves the graph properties we require.

Lastly, in step 170 the system computes the Aho-Corasick fail function F( ) using an extended algorithm. The original algorithm is extended in such a way that it is now able to deal with a graph instead of a tree. The result of this algorithm is an

Aho-Corasick DFA with a goto( ) and a fail( ) function and some added information per state.

Each of the following per state information is optional:
(a) whether the state is final or not;
(b) status bits to be set;
(c) location memory to be pushed;
(d) counters to activate;
(e) status bit to test for conditional final state or further set/push;
(f) location memory to test for conditional final state or further set/push;

The runtime algorithm is a standard Aho-Corasick augmented with proper handling of actions and conditions.

Keyword graph.

The standard Aho-Corasick algorithm operates on a keyword tree. A keyword tree for a set of patterns is a rooted tree with the following characteristics:
(a) each edge is labeled by a character;
(b) any two edges out of a node have different characters; and
(c) any path in the tree defines a unique keyword by concatenating edge labels.

We extend the concept of the keyword tree by allowing for specific types of loops. In the known art, automata in the handling of regular expressions do not have a definite structure; the edges can go more less anywhere and loops can appear inside of other loops, etc. In the automata according to the present invention, we use the combining algorithm in such a way that it has a well-defined structure containing only stable non-intersecting transverse loops.

A keyword graph is a graph with the following characteristics:
(a) there exist an “initial node” (like the root node of the keyword tree);
(b) each edge is labelled by a single character or a character set; and
(c) any two edges out of a node have disjoint character sets;
(d) any path in the tree defines a unique set of keywords by concatenating edge labels and expanding to every possible character combination from the various character sets;
(e) any two cycles in the graph do not share edges unless one contains the other;
(f) every maximal orbit is strongly stable and strongly transverse;
(g) nodes may be labeled as “terminal;” and
(h) any complex path that start from the “initial node” and reaches a terminal node represents an instance of a recognized pattern.

While it is possible to build a combined keyword graph for every expression set, in the general case this leads to a state explosion. We then use a number of techniques and expression rewriting to reduce the number of states produced. The rationale is that we modify complex expression and replace clean closure with a status bit (set after the prefix and tested after the postfix), replace ranges with location position memory (saved after the prefix and compared after the postfix) or with tail counters (if there's no postfix). If the repetition operator or the range operator is applied on a character set (and not on the wildcard) the algorithm will mask the status bits and/or the tail counters depending on every input symbol.

Overall Algorithm.

The DFA construction algorithm for a regular expression set proceeds as follows:

Step 110—regular expressions expansion.
1. Examine the set of regular expressions and perform expansion for the “+”, “?” and “{m,n}” operators (to allow building Glushkov automata for each expression) and the topmost ‘|’ operators (to have only simple expressions).

Step 120—logically connect the expanded expression.
2. Characterize the resulting expressions as belonging to:
   a) a set of keywords (that do not contain any regular expression operator);
   b) a set of simple expressions (that do not contain a closure or a range over a “large” character set, or a “long” sequence of identical “large” character sets);
   c) a set of complex expressions;

Step 130—parse the expression.
3. Transform the complex expression set:
   a) split the expression over the “problematic” parts (closure or a range over a “large” character set, or a “long” sequence of identical “large” character sets);
   b) allocate a status bit for every non problematic part;
   c) allocate a position location for every problematic range in the middle of the complex expression;
   d) allocate a tail counter for every problematic range at the end of the complex expression;
   e) add all non problematic sub expressions to the “simple expression set” marking them with a suitable combination of:
      i. status bit set;
      ii. location push;
      iii. tail counter activation;
      iv. status bit test and optional location compare followed by a match;
      v. status bit test and optional location compare followed by status bit set, optional location push, optional tail counter activation;
   f) build a mask for status bits that clears the bit if specific characters are recognized.
   g) build a mask for tail counters that clears the counter if specific characters are recognized.
   h) status bits, location positions and tail counters may be shared among expressions not overlapping in the recognized language.
4. Sort the keyword set inserting the longest keyword first.
5. Sort the simple expression set inserting the longest expression first.
6. Build a combined graph containing only the root node.
7. Combine each keyword to the combining graph.

Step 140—transform the parsed expression into a Glushkov automata.
8. Build the Glushkov NFA automata for each simple expression.
9. Build a keyword graph for each Glushkov NFA automata handling character set edge splitting.

Step 160—Combine into a keyword graph.
10. Combine each keyword graph into the combining graph.
11. Compute the F( ) function handling character set edge splitting and prefix disambiguation.

Details for the most important steps are given in the following sections.

During the initial expansion step we replace all these operators with a set of expressions recognizing the same language and containing only a subset of operators. For example we'll express the positive closure operator “+” by rewriting it using the “*”, for example “AB+C” becomes “ABB*C”; we'll “unroll” the optional operator “?” by transforming the regular expression into a set of (unique) regular expressions that recognize the same language.

For the bounded repetition operators we have the following cases:

Lower bound and upper bound “{m;n}”: we rewrite this as “m+1” times the symbol followed by “{;n−m}” upper bound only.

Lower bound and no upper bound “{m;}”: we rewrite this as “m+1” times the symbol followed by a “*”, for example “AB {m;} C” becomes “ABBB.BBB*C”.

Only upper bound “{;n}”: we rewrite this as n times the symbol followed by ‘?’.

This can generate a large number of regular expressions, but these regular expressions will be superimposed at keyword graph combining time.

Step 120—Glushkov automata to keyword graph

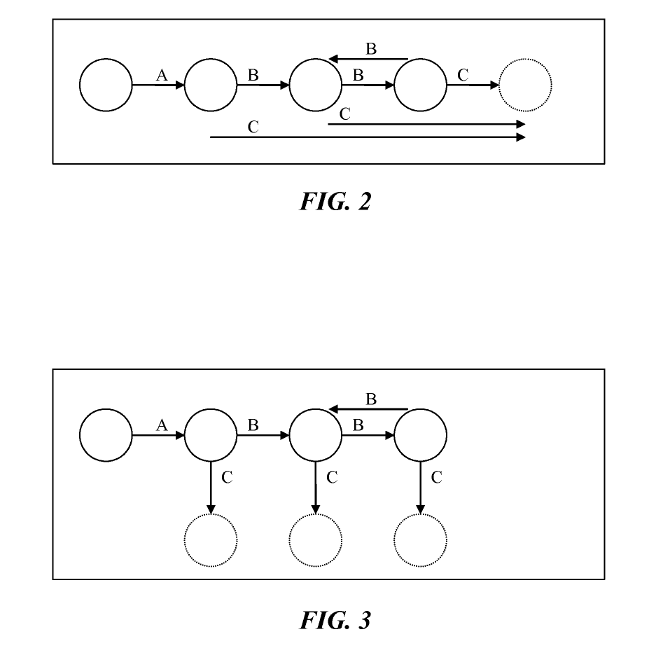

Take “AB*C”, build the Glushkov automata and unroll the “tight” loop; we obtain the keyword graph shown in FIG. 2.

When we transform the automata into a DFA, using any method, and perform a breadth first visit to build the keyword graph, we get the graph shown in FIG. 3.

Handling character class when building the Glushkov automata.

When building Glushkov NFA we can handle character classes as primitive symbols and label edges using a character class representation.

When we convert the automata into a DFA, using for example the classical state reach-ability algorithm, we need consider character sets.

The classical algorithm starts from the initial state and recursively creates new states as a combination of NFA states reachable from the current combined state using a specific symbol. When we have character set edges, we need to compute the minimal set of disjoint outgoing edges that intersect the Glushkov edges that exit the NFA state combination that was mapped onto the DFA state.

Combining keyword graphs.

We consider the keyword graph from top to bottom following the order of a breadth first visit. Define:

Nodes above—nodes that have a shorter path from the radix (node 0) in a breadth first visit;

Nodes below—nodes that have a longer path from the radix (node 0) in a breadth first visit;

ELN—enter loop node—the first node (topmost) of a loop;

LS—loop symbol—the symbol on the edge that enters the ELN from above;

BE—backward edge—all the edges that return to the ELN from a node below it;

C—the combined graph we are building

A—the graph we are adding

Nc—current node in C

Na—current node in A

Ec—an edge in C outgoing from Nc

Ea—an edge in A outgoing from Na

target(Ec)—the node of C that Ec points to

target(Ea)—the node of A that Ea points to

loop(Ec)—the set of edges defining the all loops with target(Ec) as ELN

loop(Ea)—the set of edges defining the all loops with target(Ea) as ELN

numl(Ec)—number of loops that have target(Ec) as ELN

numl(Ea)—number of loops that have target(Ea) as ELN

We combine keyword graphs starting from a graph containing only the node 0 and adding one keyword graph; the combining algorithm is designed to keep the keyword graph properties eventually replicating nodes and complete subtrees. This will allow for a compression step at the end, recognizing identical copies of subtrees and compacting them info fewer states.Loop unrolling

An important procedure we use when combining keyword graph is “graph loop unrolling”. This procedure is applied always at ELN and performs:

Find the “last loop node” LLN

Remove the BE

Copy the ELN to NNL and attach it to LLN using the BE symbol

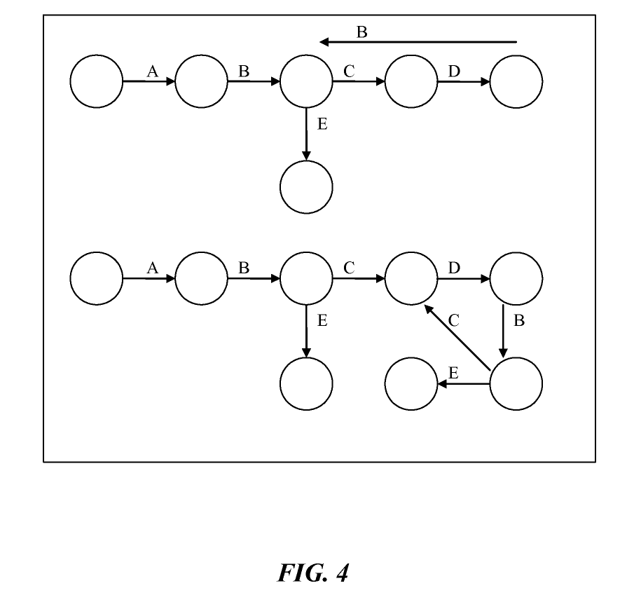

Copy all edges (and their subtrees) that exit the ELN and do not belong to the loop and attach them to NNL. See FIG. 4

Combining procedure.

We visit the graph to be added and the combined graph at once, in breadth first order (using a queue of pairs (Nc, Na) which starts containing the 2 root nodes), and we examine all edges in Na, checking the following conditions (in order!):

1. For each Ea such as does not exists an Ec such as (Ec∩Ea)≠Ø

This is a “new edge” in the combining graph.

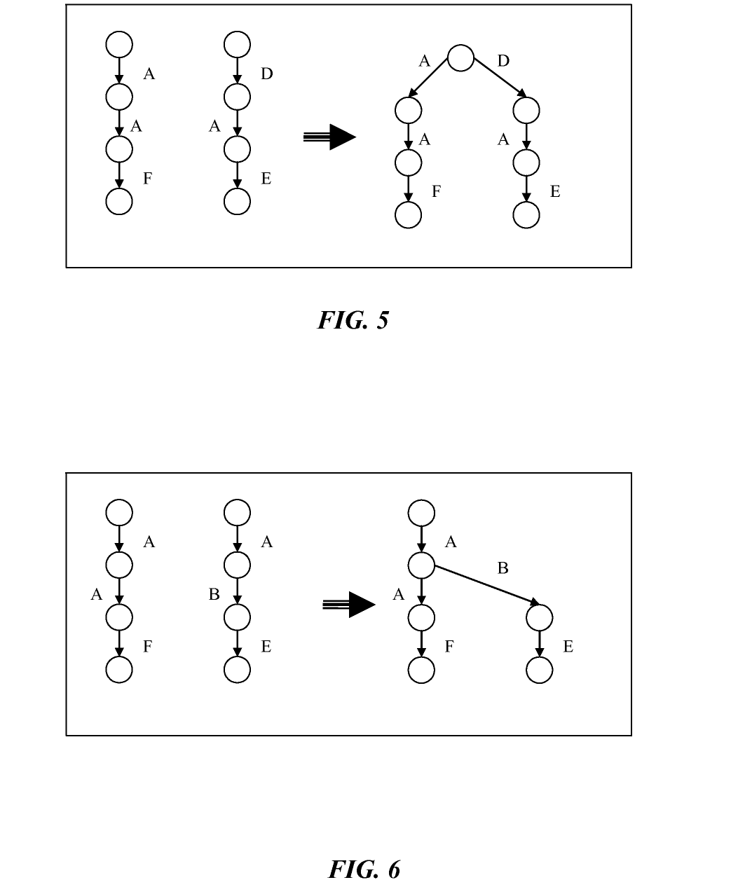

We simply add Ea to Nc and all the subtree starting from target(Ea). See FIG. 5.

2. For each Ea such as exists an Ec such as (Ec==Ea) && target(Ea) not ELN && target(Ec) not ELN

Now this is an “existing edge” in the combining graph.

We simply map target(Ea) to target(Ec) continue adding (target(Ec),target(Ea)) to work queue. See FIG. 6.

3. For each Ea such as exists an Ec such as (Ec==Ea) && target(Ea) not ELN

This means that target(Ec) is an ELN

->unroll loops from target(Ec)

Now this is an “existing edge” in the combining graph.

We simply map target(Ea) to target(Ec) continue adding (target(Ec),target(Ea)) to work queue.

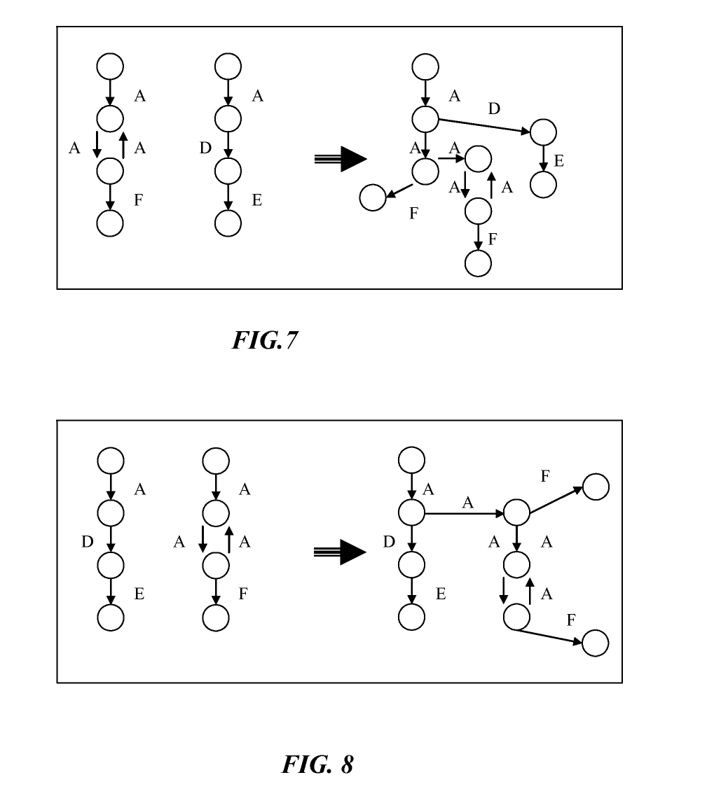

If target(Ec) is a ELN we need to unroll the loop to avoid, while recognizing the new expression symbol, to “come back” to Nc due to a closure for a different pattern. The unroll operation can happen a finite number of times because either the path in A ends (and we end with condition 2—existing edge) or the path contains a loop (and we apply condition 5 or 6—loop combining) See FIG. 7.

4. For each Ea such as exists an Ec such as (Ec==Ea) && target(Ec) not ELN

This means that target(Ea) is an ELN

->unroll loops from target(Ea)

Now this is an “existing edge” in the combining graph.

We simply map target(Ea) to target(Ec) continue adding (target(Ec),target(Ea)) to work queue.

If target(Ea) is a ELN we need to unroll the loop to avoid, while recognizing the new expression closure, to “come back” to Nc and eventually follow a different edge out from Nc belonging to a different pattern. The unroll operation can happen a finite number of times because either the path in C ends (and we fall back to condition 1—new edge) or the path contains a loop (and we apply condition 5 or 6—loop combining). See FIG. 8.

5. For each Ea such as exists an Ec such as (Ec==Ea) && (loop(Ea)==loop(Ec))

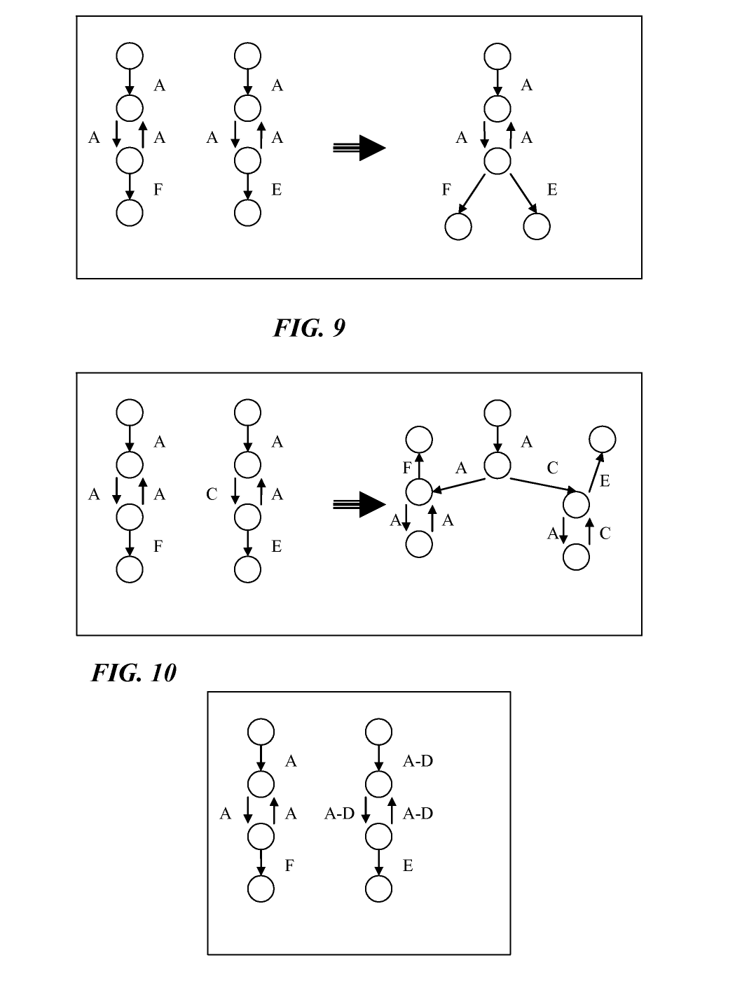

This is loop combining: we have loop(s) in A overlapping loop(s) in C and the loop(s) are the same and they are at the same position in two patterns. This means that we can simply reuse the existing loop(s) and continue adding (target(Ec),target(Ea)) to work queue. See FIG. 9

6. For each Ea such as exists an Ec such as (Ec==Ea) && (numl(Ea)==numl(Ec)==1)

This is loop combining: we have a single loop in A overlapping a single loop in C and the two loops are not equal. This means that we cannot reuse the existing loop!

We unroll the loop from target(Ea) and the loop from target(Eb) and reapply the algorithm from the start. This procedure will terminate because since the two loops are not the same we unroll both until they diverge. See FIG. 10.

7. For each Ea such as exists an Ec such as (Ec==Ea) && (numl(Ec)>=numl(Ea))

This is loop combining: we have a (less) loops in A overlapping a (more) loops in C and the loops are not equal. This means that we cannot reuse the existing loop!

We unroll the largest loop from target(Ec) and reapply the algorithm. This procedure will terminate because since the number of loops around target(Ec) is reduced by one until it is 1 (or less than numl(Ea)) and condition 6 or 8 is applied.

8. For each Ea such as exists an Ec such as (Ec==Ea) && (numl(Ec)<numl(Ea))

This is loop combining: we have a (more) loops in A overlapping a (less) loops in C and the loops are not equal. Note: This means that we cannot reuse the existing loop.

We unroll the largest loop from target(Ea) and reapply the algorithm. This procedure will terminate because since the number of loops around target(Ea) is reduced by one until it is 1 (or less than numl(Ec)) and condition 6 or 7 is applied.

9. For each Ea such as exists an Ec such as (Ec∩Ea)==Ec && target(Ea) not ELN && target(Ec) not ELN

Now this means adding a character class when there's an “existing edge” in the combining graph that overlaps with it. To combine this we modify A by copying the target(Ea) node and attaching it to Na using the label of Ec and we change the label of Ea to (Ea−Ec). We then reapply the algorithm to the new edges, which will perform an “old” edge (condition 2) and a “new” edge (condition 1) case.

10. For each Ea such as exists an Ec such as (Ec∩Ea)==Ea && target(Ea) not ELN && target(Ec) not ELN

Now this means adding a character class when there's an “existing edge” in the combining graph that overlaps with it. To combine this we modify C by copying the target(Ec) node and attaching it to Nc using the label of Ea and we change the label of Ec to (Ec−Ea). We then reapply the algorithm to the new edges, which will perform an “old” edge (condition 2) and a “new” edge (condition 1) case.

11. For each Ea such as exists an Ec such as (Ec∩Ea)≠Ec && target(Ea) not ELN && target(Ec) not ELN

Now this means adding a character class when there's an “existing edge” in the combining graph that intersects with it. To combine this we:

modify A by copying the target(Ea) subtree and attaching it to Na using the label of (Ec∩Ea);

change the label of Ea to (Ea−(Ea−Ec)).

modify C by copying the target(Ec) subtree and attaching it to Nc using the label of (Ec−(Ec∩Ea));

change the label of Ec to (Ec∩Ea).

We then reapply the algorithm to the new edges, which will perform an “old” edge (condition 2) and either a “new” edge (condition 1) or again condition 11 for character class clash with another existing edge.

12. For each Ea such as exists an Ec such as (Ec∩Ea) && target(Ea) not ELN

This means that target(Ec) is an ELN

->unroll loops from target(Ec)

We then apply again the algorithm, which will perform non loop character class combining (condition 10 or 11). This unroll operation will happen a finite number of times for the same reason of condition 3.

13. For each Ea such as exists an Ec such as (Ec∩Ea) && target(Ec) not ELN

This means that target(Ea) is an ELN

->unroll loops from target(Ea)

We then apply again the algorithm, which will perform non loop character class combining (condition 10 or 11). This unroll operation will happen a finite number of times for the same reason of condition 4.

14. For each Ea such as exists an Ec such as (Ec∩Ea)==Ec

This is loop combining with character class clash: adding a character class when there's an “existing edge” in the combining graph that is contained inside it and we have a loop in A but not in C. To be able to map this we change the graph in A.

We need to support 2 cases:

Loops that contain only edges with Ea label. In this case we:

Copy target(Ea) subtree to Nt.

Unroll all loops on Nt.

Connect source(Ea) to a copy of Nt using label (Ea-Ec).

Start following the loop edges (including the loop enter edge Ea) until you reach the backward edge doing:

Change edge label to Ec

Change Nt subtree “following” the edge with label Ea and then unrolling all loops on the new Nt subtree root.

Connect the edge target node to a copy of Nt using label (Ea-Ec).

Loops that contain edges with labels different from Ea. In this case we:

Copy target(Ea) subtree to Nt.

Unroll all loops on Nt.

Connect source(Ea) to a copy of Nt using label (Ea-Ec).

Start following the loop edges (including the loop enter edge Ea) until you reach an edge with different label doing:

Unroll the loop

Change edge label to Ec

Change Nt subtree “following” the edge with label Ea and then unrolling all loops on the new Nt subtree root.

Connect the edge target node to a copy of Nt using label (Ea-Ec).

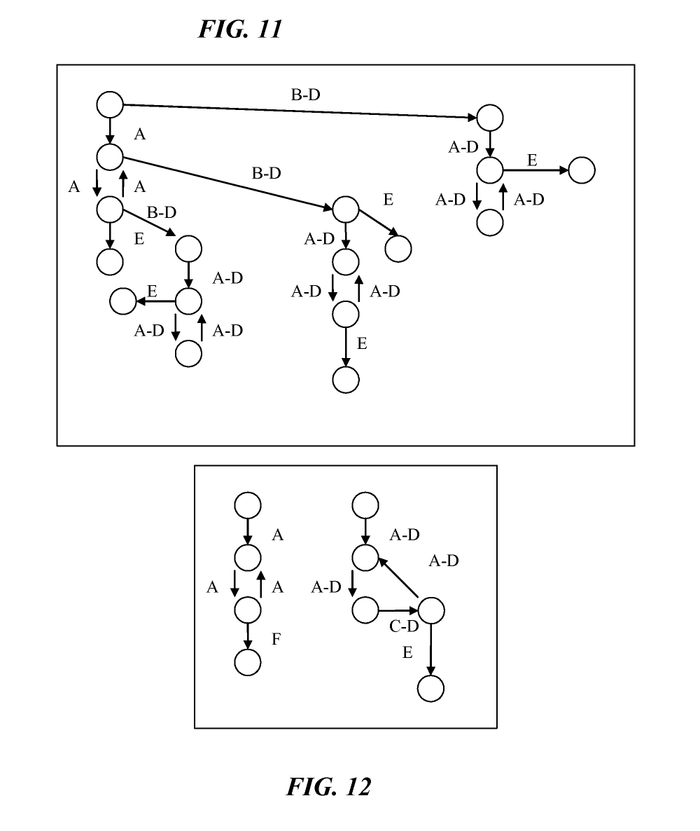

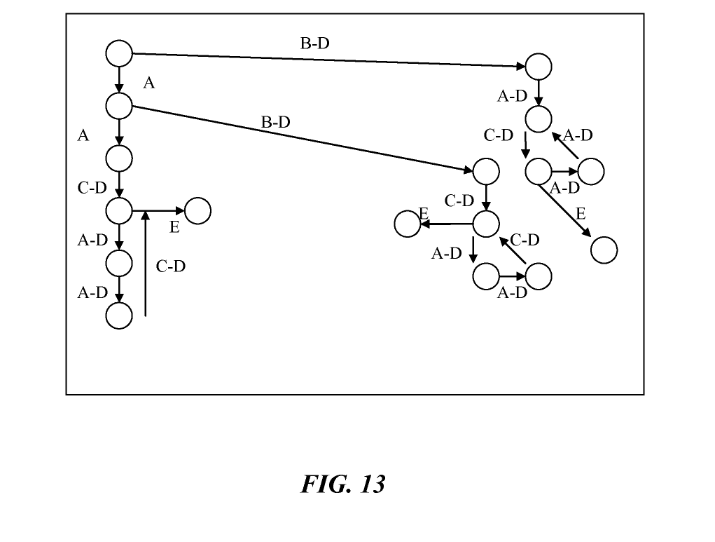

For example if the 2 loops (fragments of C and A) are like the graph shown in FIG. 11. The A loop contains only Ea labels; we transform the A loop into (see FIG. 12). Which can be combined to the first one (C) using other conditions: for example B-D is a new edge while A is an existing edge to an isomorph loop, etc. If instead the two loops to combine are as shown in FIG. 13.

We transform A loop into that shown in FIG. 13.

15. For each Ea such as exists an Ec such as (Ec∩Ea)==Ea.

This is a loop combining with character class clash: adding a character class when there's an “existing edge” in the combining graph that is contained inside it and we have a loop in C but not in A. This is the dual case for 14 and is handled in the same way.

Computing fail( )

The fail function computation uses the basic algorithm designed for Aho-Corasick. The purpose of the fail function is to identify the longest proper prefix of another keyword (pattern in our case) already recognized while matching the current one. The algorithm performs a breadth first visit of the graph, computing the F( ) of child nodes using the F( ) of the parent node. The depth first visit ensures that, if n is the length of the path from the radix to the current node, all patterns with length n−1 have a correct F( ) function defined.

The original algorithm must be modified for handling two conditions arising in the keyword graph:

Loops—this means prefix disambiguation

Character classes—this means subtree disambiguation

Prefix disambiguation.

When the fail ( ) computation crosses a loop in the graph, and in particular reaches a BE (backward edge) it will need to compute the fail ( ) for a node which already has an fail ( ) defined. In this case the computation must compute a new fail ( ) function using the backward edge source node and compare it with the already computed one. If the length of recognized path for the new fail ( ) is strictly longer than the old one then the loop must be unrolled once and processing continued.

An example where this happens is when computing the F( ) function of the combination of “A(BC)*D” and “BCBCBCE”. The loop defined by the “(BC)*” closure will not be unrolled during combining (since it is “under” an “A” symbol) but it will be completely unrolled 2 times when computing fail ( ). The third time the new fail ( ) computed on the backward edge will be equal to the one already present since there exist no longer pattern.

The unrolling procedure will terminate because two (or more) loops cannot force each other to unroll, since they have a different prefix. If they had the same prefix they would have been combined.

Subtree disambiguation.

When following fail ( ) backwards for a node reached using a charclass we may encounter partial matches . . . this happens when there exists prefixes which overlap with the edge character class. To solve the ambiguity we need to duplicate the target node splitting the edges. This procedure will replicate all node outgoing edges and create cases in which you can reach a node not inside a loop using two edges with (potentially) different fail( ) functions. When you reach a node that already has an fail( ) defined, you compute the fail( ) using the current edge and, if is different, you duplicate the target node.

Final compilation steps.

At the end of the combining procedure a large number if identical subtrees may have been generated. The fail( ) computation may generate more identical copies of subtrees. We can then compress the resulting graph by starting from the leaves (that are terminal nodes), group them into sets that recognize the same regular expression set and work our way towards the top of the graph reusing identical subtrees. We then cleanup the graph removing all unreachable nodes and pre-compute the result of following the fail( ) function for every possible symbol for every node in order to have only forward transitions.

Runtime algorithm.

At runtime the regular expression matcher works on a suitable representation of the graph containing for each node:

the “forward transition table”, containing the next node for every possible input symbol

whether the state is “final” or not

the status bit to set

the (zero or more) locations to push

the tail counter to start and its initial value

a list of complex tests, each of which contains:

a) a status bit test mask

b) an optional location compare (min and max value)

c) whether the state is “final” or not if test is successful

d) status bit to set if test is successful

e) the (zero or more) location to push if test is successful

f) the tail counter to start and its initial value if test is successful

the status bit test mask, which is an or of all test masks for every test

The DFA defines also two global masks:
the status bit clear mask, which clears status bits depending on input symbols
   the tail counter clear mask, which clears tail counters depending on input symbols

The algorithm uses a state machine status containing:

the current status bit set

the current location position set

the current active counters, with their value and recognized expression ID if the value reaches 0

The runtime algorithm for each input symbol is:

clear current status bit set depending on input symbol

disable tail counter depending on input symbol

decrement all (active) counters—test for 0 and report matches

follow the transition table depending on the input symbol and reach a new state

if the new state is final report a match
compute new status bits by OR-ing the current status bit set with the new state status bit set
optionally save the current stream position inside one or more position locations
optionally activate counters
check if complex tests are required by AND-ing the current status bit set with the status bit test mask

if the “and” is not empty loop over each test and:

a) check if the test matches by AND-ing its status bit test mask with the current status bit set

b) if the test requires a location comparison compare a saved location position with provided range values

c) if the tests are true:

d) clear status bits by AND-ing with the negation of the status bit test mask e) optionally report a match

f) compute new status bits by OR-ing the current status bit set with the test status bit set

g) optionally push locations

h) optionally activate tail counters

The search is directed towards regular expression pattern matching using keyword graphs by using modified Aho-Corasick algorithm to match regular expression instead of keywords and then parsed and transformed into Glushkov automata, which is an NFA formalism with “interesting” properties, such as being epsilon free, homogeneous and strongly stable for every maximal orbit. The Glushkov automata are then converted into DFA while maintaining the fundamental property. The DFA-Glushkov is combined into a keyword graph and then the Aho-Corasick fail function F( ) is computed. The resulting graph can be executed by an unmodified Aho-Corasick engine at same matching speed and match a large class of expressions.

In the above description, numerous specific details are set forth by way of exemplary embodiments in order to provide a more thorough description of the present invention. It will be apparent, however, to one skilled in the art, that the present invention may be practiced without these specific details. In other instances, well-known features have not been described in detail so as not to obscure the invention. The preferred embodiments of the inventions are described herein in the Detailed Description, Figures and Claims. Unless specifically noted, it is intended that the words and phrases in the specification and claims be given the ordinary and accustomed meaning as understood by those of skill in the applicable art. If any other meaning is intended, the specification will specifically state that a special meaning is being applied to a word or phrase.

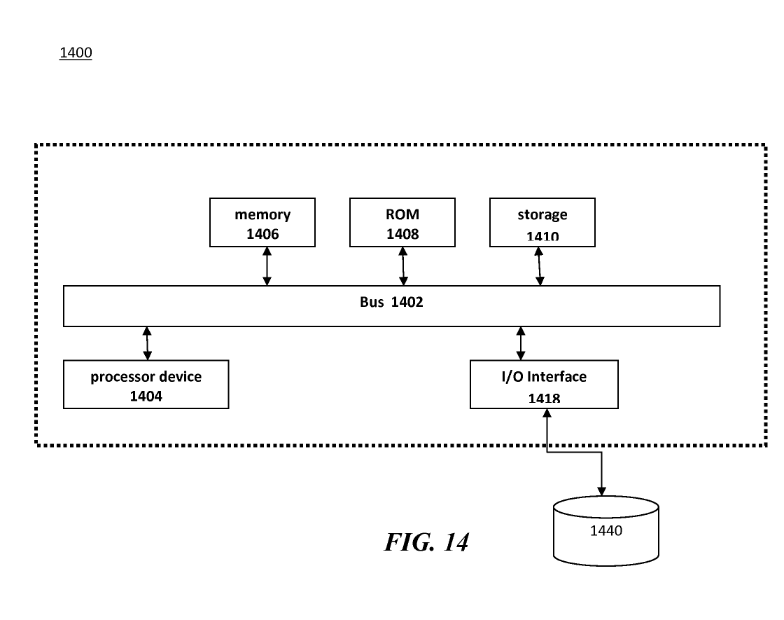

In an embodiment of the invention, a computer system 1400 is illustrated in FIG. 14. Computer system 1400, illustrated for exemplary purposes as a networked computing device, is in communication with other networked computing devices (not shown) via a network. As will be appreciated by those of ordinary skill in the art, the network may be embodied using conventional networking technologies and may include one or more of the following: local area networks, wide area networks, intranets, public Internet and the like. In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Throughout the description above, an embodiment of the invention is illustrated with aspects of the invention embodied solely on computer system 1400. As will be appreciated by those of ordinary skill in the art, aspects of the invention may be distributed amongst one or more networked computing devices which interact with computer system 1400 via one or more data networks. However, for ease of understanding, aspects of the invention have been embodied in a single computing device—computer system 1400.

Computer system 1400 includes processing system (CPU) 1404 which communicates with various input devices, output devices and the network. Input devices may include, for example, a keyboard, a mouse, a scanner, an imaging system (e.g., a camera, etc.) or the like. Similarly, output devices may include displays, information display unit printers and the like. Additionally, combination input/output (I/O) devices may also be in communication with processing system 1404 through the Input/output interface 1418. Examples of conventional I/O devices include removable and fixed recordable media (e.g., CD-ROM drives, DVD-RW drives, and others), touch screen displays, and the like.

The CPU is a processing unit, such as an Intel Pentium™, IBM PowerPC™, Sun Microsystems UltraSparc™ processor or the like, suitable for the operations described herein. Processor device 1404 may be embodied as a multi-processor system. In an embodiment of the present invention, the processor device 1404 functions as a compiler. As will be appreciated by those of ordinary skill in the art, other embodiments of processing system 1404 could use alternative CPUs and may include embodiments in which one or more CPUs are employed. The CPU may include various support circuits to enable communication between itself and the other components of processing system 1404.

Memory 1406 includes both volatile and persistent memory for the storage of: operational instructions for execution by CPU 1404, data registers, application storage and the like. The memory 1406 preferably includes a combination of random access memory (RAM), read only memory (ROM) and persistent memory such as that provided by a hard disk drive. Storage 1410 is provided for storing any data, instructions, algorithms, formulas, graphs, and so forth as required by the invention.

I/O I/F 1418 enables communication between processor device 1418 and the various I/O devices. I/O I/F 1418 may include, for example, a video card for interfacing with an external display such as output device. Additionally, I/O I/F 1418 may enable communication between processing system 1400 and a removable media. Although the removable media can be a conventional diskette other removable memory devices such as Zip™ drives, flash cards, CD-ROMs, static memory devices and the like may also be employed. Removable media 1440 may be used to provide instructions for execution by CPU 1404 or as a removable data storage device.

The computer instructions/applications, such as the algorithms described above, stored in memory 1406, are executed by CPU 1404, thus adapting the operation of computer system 1400 as described herein. Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method of recognizing a regular expression match from a regular expression set in real time, said method comprising:
using an input/output interface for obtaining the regular expression set;
using a processor device configured to perform:
expanding the regular expression set into an expanded expression set that recognizes a same language as the regular expression set and comprises more expressions than the regular expression set, with less operators per expression;
wherein the expanding comprises logically connecting the expressions in the regular expression set;
parsing the expanded expression set;
transforming the parsed expanded expression set into a Glushkov automata;
transforming the Glushkov automata into a deterministic finite automaton (keygraph DFA) maintaining specific graph properties;
combining the keygraph DFA into a global keyword graph DFA using a combining algorithm that preserves the fundamental graph properties; and
computing an Aho-Corasick fail function for the global keyword graph using a modified algorithm to produce a modified Aho-Corasick graph with a goto( ) and a fail function and added information per state; wherein said modified Aho-Corasick graph can be executed by an unmodified Aho-Corasick engine at a same matching speed and match a large class of expressions.

2. The method of claim 1 wherein logically connecting the expressions comprises using a set of connection operators comprising status bits, location memory, and counters.

3. The method of claim 1 wherein obtaining the regular expression set comprises obtaining said regular expression set from a dynamic/non-persistent transitory, fast moving input stream.

4. The method of claim 1 further comprising adding additional regular expression to the regular expression set at a later time.

5. The method of claim 1 further comprising computing a fail function for a global keygraph DFA.

6. The method of claim 5 further comprising mapping the global keygraph DFA to the Aho-Corasick algorithm for recognition from input stream and which modifies the global keygraph DFA and sets a fail function for each state which can then recognize regular expressions in every position of the input stream.

7. The method of claim 5 further comprising simplifying the global keygraph DFA to remove redundancies.

8. The method of claim 5 further comprising a-runtime algorithm with status bits (locations, counters, etc.) which modify the preprocessing steps to keep from having an exponential number of states.

9. An information processing system comprising:
an information processing device configured for:
expanding a regular expression set into an expanded expression set that recognizes a same language as the regular expression set and comprises more expressions than the regular expression set, with less operators per expression;
wherein the expanding comprises logically connecting the expressions in the regular expression set;
parsing the expanded expression set;
transforming the parsed expanded expression set into a Glushkov automata;
transforming the Glushkov automata into a deterministic finite automaton (keygraph DFA) maintaining specific graph properties;
combining the keygraph DFA into a global keyword graph DFA using a combining algorithm that preserves the fundamental graph properties;
computing an Aho-Corasick fail function for the global keyword graph using a modified algorithm to produce a modified Aho-Corasick graph with a goto( ) and a fail function and added information per state; wherein said modified Aho-Corasick graph can be executed by an unmodified Aho-Corasick engine at a same matching speed and match a large class of expressions.

10. A computer readable storage medium comprising program instructions for:
expanding a regular expression set into an expanded expression set that recognizes a same language as the regular expression set and comprises more expressions than the regular expression set, with less operators per expression;
wherein the expanding comprises logically connecting the expressions in the regular expression set;
parsing the expanded expression set;
transforming the parsed expanded expression set into a Glushkov automata;
transforming the Glushkov automata into a deterministic finite automaton (keygraph DFA) maintaining specific graph properties;
combining the keygraph DFA into a global keyword graph using a combining algorithm that preserves the fundamental graph properties;
computing an Aho-Corasick fail function for the global keyword graph using a modified algorithm to produce a modified Aho-Corasick graph with a goto( ) and a fail function and added information per state; wherein said modified Aho-Corasick graph can be executed by an unmodified Aho-Corasick engine at a same matching speed and match a large class of expressions.
